(19) United States
(12) Patent Application Publication
(10) Pub. No.: US 2012/0194588 A1
(43) Pub. Date: Aug. 2, 2012

(54) PRINTING APPARATUS AND PRINTING METHOD

(75) Inventor: Tsuneo Kasai, Azumino-shi (JP)

(73) Assignee: SEIKO EPSON CORPORATION, Tokyo (JP)

(21) Appl. No.: 13/360,023

(22) Filed: Jan. 27, 2012

(30) Foreign Application Priority Data
Jan. 28, 2011 (JP) 2011-016160

(51) Int. Cl. B41J 29/38

(52) U.S. Cl. 347/14

(57) ABSTRACT

Inspection patterns of each ink are printed on a transparent medium, by the use of a print head having a plurality of nozzle groups which discharges multiple types of ink, respectively. The inspection patterns printed on the transparent medium are read by the sensor. When reading the inspection patterns, the background color is switched, by the use of a background color switching section which faces the sensor with the inspection patterns interposed therebetween and in which a background color is switched. An occurrence of a defective nozzle is determined based on a reading result of the sensor.

### BACKGROUND

1. Technical Field

The present invention relates to a printing apparatus and a printing method.

2. Related Art

In an ink jet type printing apparatus, among a plurality of nozzles for discharging ink included in a print head, in some cases, ink is not discharged or an ink discharging amount and an ink droplet shot position are improper in some nozzles, for some reason, whereby nozzles having a defective discharging state of ink (hereinafter, also referred to as defective nozzles) may be generated. From the related art, as techniques of detecting the defective nozzles, for example, JP-A-2010-058361, JP-A-2006-069027, JP-A-2006-069028, and JP-A-2010-194839 are known.

JP-A-2010-058361 discloses a technique which detects the defective nozzles by reading an inspection pattern printed on margins of paper by a image sensor. Furthermore, JP-A-2006-069027 and JP-A-2006-069028 disclose a technique which detects the defective nozzles by reading the inspection pattern printed on a transparent film from the back side of the printed surface by an image sensor (an image pickup element). Furthermore, JP-A-2010-194839 discloses a technique of using a matter in which a base by black ink is printed on a portion of a pattern of white ink as an inspection pattern, and then a pattern of white ink is printed.

However, in the techniques of JP-A-2010-058361, JP-A-2006-069027 and JP-A-2006-069028, when a difference in color between the discharged ink and the paper is small, a change in characteristic amount to be detected by the sensor becomes smaller, and detection accuracy drops. For example, in a case of printing the white ink or transparent ink on white paper, there is a high possibility of it not being possible to detect the defective nozzle.

Furthermore, in the technique of JP-A-2010-194839, the detection accuracy of the defective nozzle of the white ink is improved, but there is an extra need for a basic printing processing by black ink in the printing of the inspection pattern, and there was a problem to be improved in terms of time required for detection of the defective nozzle.

### SUMMARY

An advantage of some aspects of the invention is to provide a technique which enables the detection of the defective nozzles of various inks to accurately be performed.

### APPLICATION EXAMPLE 1

A printing apparatus includes a print head having a plurality of nozzle groups which discharges multiple types of ink, respectively; a print control section which controls the operation of the print head, and prints inspection patterns of each ink on a transparent medium; a sensor which reads the inspection patterns printed on the transparent medium; a background color switching section which faces the sensor with the inspection pattern interposed therebetween and in which the background color is switched; and a defect determination section which determines an occurrence of a defective nozzle based on a reading result in which the background color and the inspection pattern are read by the sensor.

According to the printing apparatus, since it is possible to switch the background color depending on the type of ink and increase a difference in intensity of light between a portion of ink read by the sensor and a portion of the background, it is possible to accurately perform the detection of the defective nozzles of various inks.

### APPLICATION EXAMPLE 2

The printing apparatus according to Application Example 1, wherein the background color switching section switches the background color depending on the type of ink of the read inspection pattern.

### APPLICATION EXAMPLE 3

The printing apparatus according to Application Example 1 or 2, wherein the background color switching section has a background plate.

### APPLICATION EXAMPLE 4

The printing apparatus according to Application Example 1 or 2, wherein the background color switching section has a film.

### APPLICATION EXAMPLE 5

The printing apparatus according to Application Example 1 or 2, wherein the background color switching section has a liquid crystal panel.

### APPLICATION EXAMPLE 6

The printing apparatus according to any one of Application Examples 1 to 5, wherein the multiple types of ink include at least one of white ink and transparent ink, and when the type of ink of the read inspection pattern is the white ink or the transparent ink, the background color is black.

According to the printing apparatus, when the type of ink of the read inspection pattern is the white ink or the transparent ink, the background color is set to black, whereby a difference in intensity of light between the portion of the white ink or the transparent ink read by the sensor and the portion of the background can be the largest. Thus, it is possible to accurately perform the detection of the defective nozzle of the white ink or the transparent ink.

### APPLICATION EXAMPLE 7

The printing apparatus according any one of Application Examples 1 to 6, wherein the multiple types of ink include a plurality of color inks, when the type of ink of the read inspection pattern is one color ink among the plurality of color inks, the background color includes at least a component of a complementary color in a color circle of the one color.

According to the printing apparatus, when the type of ink of the read inspection pattern is one color among a plurality of color inks, the background color is set to color including at least the component of the complementary color in the color circle of the one color, whereby it is possible to increase a difference of intensity of light of the complementary color between the portion of ink read by the sensor and the portion of the background. Thus, the detection of the defective nozzle of the one color ink can be accurately performed, whereby it is possible to accurately perform the detection of each defective nozzle of the plurality of color inks.

### APPLICATION EXAMPLE 8

The printing apparatus according to Application Example 7, wherein, when the type of ink of the read inspection pattern is one color ink among the plurality of color inks, the background color is the complementary color in the color circle of the one color.

According to the printing apparatus, the type of ink of the read inspection pattern is one color of the plurality of color inks, the background color is set to the complementary color in the color circle of the one color, whereby the difference of intensity of light of the complementary color between the portion of ink read by the sensor and the portion of the background can be the largest. Thus, it is possible to accurately perform the detection of the defective nozzle of one color ink, whereby the detection of each defective nozzle of the plurality of color inks can more accurately be performed.

### APPLICATION EXAMPLE 9

A printing method includes printing an inspection pattern of each ink on a transparent medium by the use of a print head having a plurality of nozzle groups which discharges multiple types of ink, respectively; reading the inspection pattern printed on the transparent medium by the use of a sensor; switching a background color by the use of a background color switching section which faces the sensor with the inspection pattern interposed therebetween and in which the background color is switched when reading the inspection pattern; and determining an occurrence of a defective nozzle based on a reading result in which the background color and the inspection pattern are read, by the sensor.

According to the printing method, since it is possible to switch the background color depending on the type of ink and increase a difference in intensity of light between the portion of ink read by the sensor and the portion of the background, it is possible to accurately perform the detection of the defective nozzles of various inks.

### BRIEF DESCRIPTION OF THE DRAWINGS

The invention will be described with reference to the accompanying drawings, wherein like numbers reference like elements.

FIG. 1 is an explanatory diagram that shows a schematic configuration of a printer of a first embodiment of the invention.

FIGS. 2A and 2B are explanatory diagrams that describe a configuration of the printer head.

FIGS. 3A and 3B are explanatory diagrams that show a background color switching mechanism from a transverse direction of FIG. 1.

FIG. 4 is a flow chart that shows a flow of the inspection of the defective nozzle performed by the printer.

FIG. 5 is an explanatory diagram that shows an inspection pattern.

FIG. 6 is an explanatory diagram that shows a difference in reading results generated depending on the type of ink.

FIGS. 7A and 7B are explanatory diagrams that show a difference in reading results of dot patterns of a clear ink and a white ink generated by the background color.

FIG. 8 is an explanatory diagram that shows a relationship between the type of ink and the background color.

FIGS. 9A to 9C are explanatory diagrams that show a defect determination according to the reading result of the inspection pattern.

FIG. 10 is an explanatory diagram that shows a modified example of a background color switching mechanism.

FIG. 11 is an explanatory diagram that shows another modified example of the background color switching mechanism.

### DESCRIPTION OF EXEMPLARY EMBODIMENTS

The invention will be described based on an embodiment.

### A. EMBODIMENT

### A1. Configuration of Printer

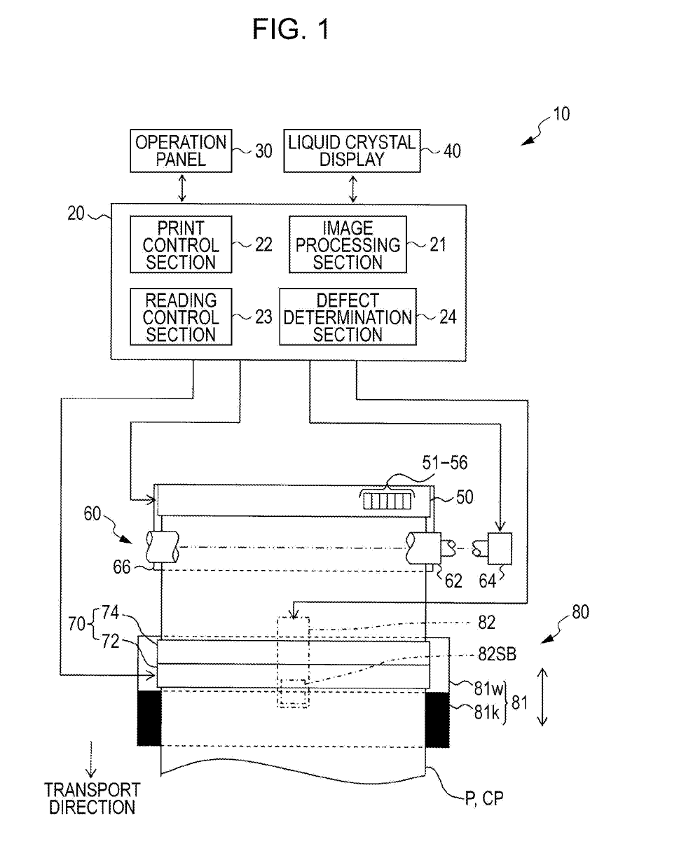

FIG. 1 is an explanatory diagram that shows a schematic configuration of the printer as a first embodiment of the invention. A printer (a printing apparatus) 10 is an ink jet type line printer. The printer 10 includes a control unit 20, a printer head 50, ink cartridges 51 to 56, a transport mechanism 60, a reading mechanism 70, and a background color switching mechanism 80.

The transport mechanism 60 includes a transport roller 62, a transport motor 64, and a platen 66. The transport motor 64 transports a print medium P passing between the printer head 50 and a flat plate-shaped platen 66 by rotating the transport roller 62 in a direction (hereinafter, referred to as a transport direction) perpendicular to an axial direction of the transport roller 62.

The ink cartridges 51 to 56 include back (K), cyan (C), magenta (M), yellow (Y), white (W), and clear (CL) inks. In addition, back (K), cyan (C), magenta (M), and yellow (Y) inks are collectively called a normal ink, and white (W) and clear (CL) ink are collectively called a special ink.

The printer head 50 is a line head type printer. On a surface (a lower surface)thereof facing the print medium P, a row of ink discharging nozzle generally placed in a row for each ink color is arranged along a transport direction of the print medium P. The Individual nozzles include piezoelectric elements, and vibration of the piezoelectric element is controlled by adjusting the voltage to be applied to the piezoelectric element to discharge ink droplets. Thus, on the print medium P to be transported by the transport mechanism 60 in the transport direction, dots by ink discharged from each nozzle provided in the printer head 50 are formed. As a result, during normal printing, on a paper as the print medium P, an image corresponding to the image data input as a print target is printed. Furthermore, when inspecting a defective nozzle described below, an established inspection pattern is printed on an inspecting transparent film as the print medium P.

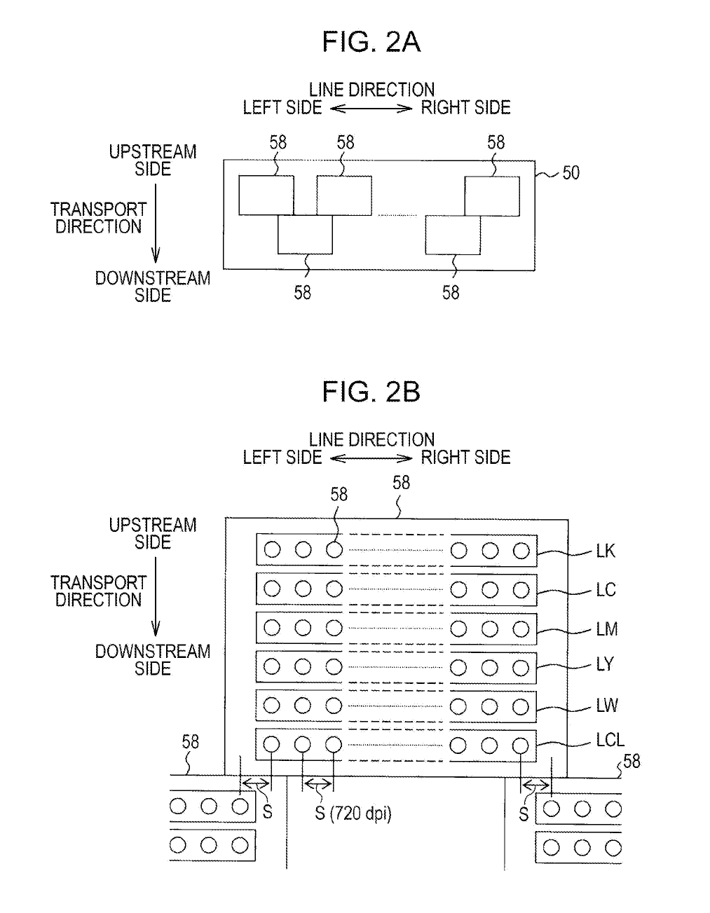

FIGS. 2A and 2B are explanatory diagrams that describe a configuration of the printer head. As shown in FIG. 2A, the printer head 50 has a plurality of heads 58, and the plurality of heads 58 is placed in a row in a zigzag pattern in a direction (hereinafter, also referred to as a line direction) perpendicular to the transport direction. As shown in FIG. 2B, on lower surfaces of each head 58, rows (hereinafter, referred to as a nozzle row) LK, LC, LY, LW, and LCL of nozzles each discharging each ink of black (K), cyan (C), magenta (M), yellow (Y), white (W), and clear (CL) are placed along the transport direction. Each nozzle row includes a plurality of nozzles 581, and each nozzle 581 is arranged at a certain interval S in the line direction, for example, “720 dpi”. Furthermore, each head 58 is placed so that an interval in the line direction between a nozzle of a right end of a left head and a nozzle of a left end of a right head is identical to the certain interval S of each nozzle of two heads arranged in the line direction. That is, on the lower surface of the printer head 50, a plurality of nozzles is arranged at a certain interval S (720 dpi) over the print medium P in the line direction. In addition, in the present embodiment, each nozzle is placed in a row for each color ink, but the nozzles for each color may be arranged and formed in two rows or more in a zigzag shape. Furthermore, the printer head 50 is configured so that the plurality of heads 58 is placed in a row in the zigzag shape, but the printer head may be formed by one head in which a plurality of nozzles for each color is placed in a row over the length of the print medium P in the line direction, respectively.

The reading mechanism 70 of FIG. 1 includes a image sensor 72 and a light source 74. The light source 74 is a white light source which emits an illumination light to a reading position of the image sensor 72, for example, a fluorescent lamp, a xenon lamp, an LED or the like. In the present embodiment, the LED is used as the light source 74. The image sensor 72 is a sensor that senses a reflective light in the reading position. In the present embodiment, as the image sensor 72, a color imaging element (an image sensor) capable of sensing each RGB color light, for example, a color CCD (Charged-coupled device) is used.

The background color switching mechanism 80 is placed to face the reading mechanism 70, and switches the background color of an inspecting transparent film as the print medium P transported to the reading position of the image sensor 72, depending on the type of ink of the inspection pattern printed on the inspecting transparent film, when inspecting the defective nozzle.

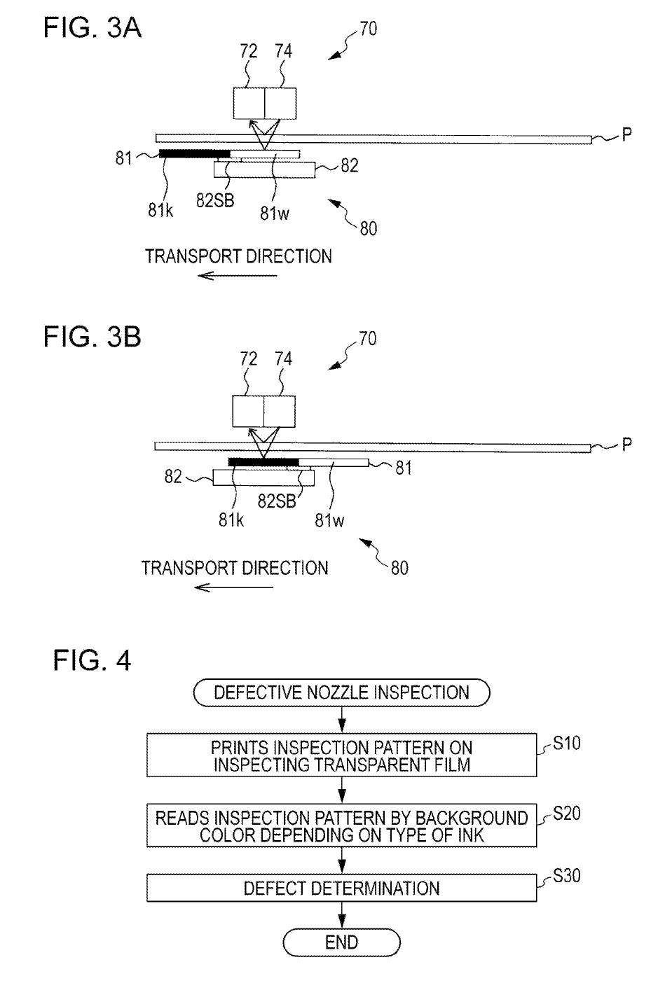

FIGS. 3A and 3B are explanatory diagrams that show the background color switching mechanism 80 from a transverse direction of FIG. 1. As shown in FIGS. 1, 3A and 3B, the background color switching mechanism 80 includes a background plate 81 and a linear actuator 82, and is placed so as to face the reading mechanism 70. The background plate 81 is configured so that a white region 81w and a black region 81k are placed along the transport direction. The linear actuator 82 moves the position of the background plate 81 mounted on a slide base 82SB along the transport direction. As a result, when inspecting the defective nozzle, it is possible to switch the background color of the inspecting transparent film as the print medium P transported to the reading position of the image sensor 72 to any one of white by the white region 81w of the background plate 81 or black by the black region 81k. In addition, details of the switching of the inspection pattern and the background color will be described below.

When the inspecting transparent film as the print medium P sequentially formed with the dots by each ink as the inspection pattern passes through an optical path of the illumination light emitted by the light source 74 through the transportation by the transport mechanism 60, the light source 74 irradiates a portion of the inspecting transparent film corresponding to the reading position of the image sensor 72 with the illumination light, and the image sensor 72 senses the reflective light returning via the inspecting transparent film and the background plate 81. As a result, the image sensor 72 reads the inspection pattern printed on the inspecting transparent film for each line passing through the reading position by the transportation.

In addition, the image sensor 72 is placed so that it can sufficiently sense the reflective light from the print medium P and the background plate 81 in the reading position as a relative position relationship between the image sensor 72 and the light source 74. The image sensor 72 is constituted by a CCD line sensor, and resolution thereof in the line direction is identical to the interval S (720 dpi) of the nozzles. However, the resolution of the CCD line sensor may be any value in a possible range if the resolution is equal to or greater than the resolution of the line direction of the printer head 50.

The control unit 20 of FIG. 1 is constituted by a CPU, a RAM, and a ROM not shown, and controls the operation of printer head 50, the transport mechanism 60, and the background color switching mechanism 80 mentioned above. The CPU is operated as the image processing section 21, a print control section 22, a reading control section 23, and a defect determination section 24 by expanding and executing the control program stored in the ROM to the RAM. Furthermore, various interfaces and peripheral devices such as an operation panel 30 for performing various operations concerning the printing or a liquid crystal display 40 for displaying UI (a user interface) are connected to the control unit 20.

The image processing section 21 performs the image processing which converts an image data (also called an input image data) of a print target input from a computer or the like via an interface (not shown), or the inspection pattern data stored in the ROM in advance into the print data. Furthermore, the image processing section 21 creates the image data (also called a reading image data) from the signal that is output from the reading mechanism 70 via the reading control section 23.

The print control section 22 outputs the control signal, which controls the discharging of each nozzle, to the printer head 50 based on the print data after the image processing. In addition, the print control section 22 controls the operation of the transport mechanism 60.

The reading control section 23 controls the operation of the reading mechanism 70 and the background color switching mechanism 80 when inspecting the defective nozzle, executes the reading of the inspection pattern printed on the inspecting transparent film as the print medium P, controls the operation of the image processing section 21, and executes the creation of the reading image data.

The defect determination section 24 performs the determination presence or absence of an occurrence of the defective nozzle and the specification of the defective nozzle, based on the reading image data and the inspection pattern data read by the reading mechanism 70.

As mentioned above, the printer 10 starts the printing processing based on the input image data when information on the printing such as the printing image data, the number of printing sheet, or the printing size is input. Furthermore, the printer 10 executes the printing processing based on the inspection pattern data, the reading of the print pattern printed on the inspecting transparent film, and the defect determination, when the start instruction is input via the interface or via the operation panel 30. The present embodiment is characterized by the inspection of the defective nozzle, and the inspection of the defective nozzle will be described below.

### A2. Deffective Nozzle Inspection

The inspection of the defective nozzle is a process of detecting abnormality of the discharge state (hereinafter, also called a nozzle defect) of ink from each nozzle 581 included in the printer head 50. The nozzle defect, for example, includes a state in which the nozzle is clogged by ink solidified in the nozzles, a state in which ink is not discharged by a defined amount, or a state in which ink is not completely discharged, on the contrary, a state in which ink is discharged more than the defined amount or the like. In addition, there is a state in which the nozzle is deformed for some reasons, and ink is not discharged in the defined discharging direction. The nozzle, in which abnormality is generated in the discharging state of ink, is called a defective nozzle.

In the inspection of the defective nozzle of the present embodiment, as described below, the printing based on the inspection pattern data is performed by the use of a colorless inspecting transparent film as the print medium P, the printed inspection pattern is read, and it is detected whether or not the nozzle defect is generated based on the obtained reading image data and the inspection pattern data.

FIG. 4 is a flow chart that shows a flow of the inspection of the defective nozzle performed by the printer 10. As mentioned above, when the instruction of the inspection of the defective nozzle is input, the printing of the inspection pattern is executed on the inspecting transparent film set as the print medium P (step S10).

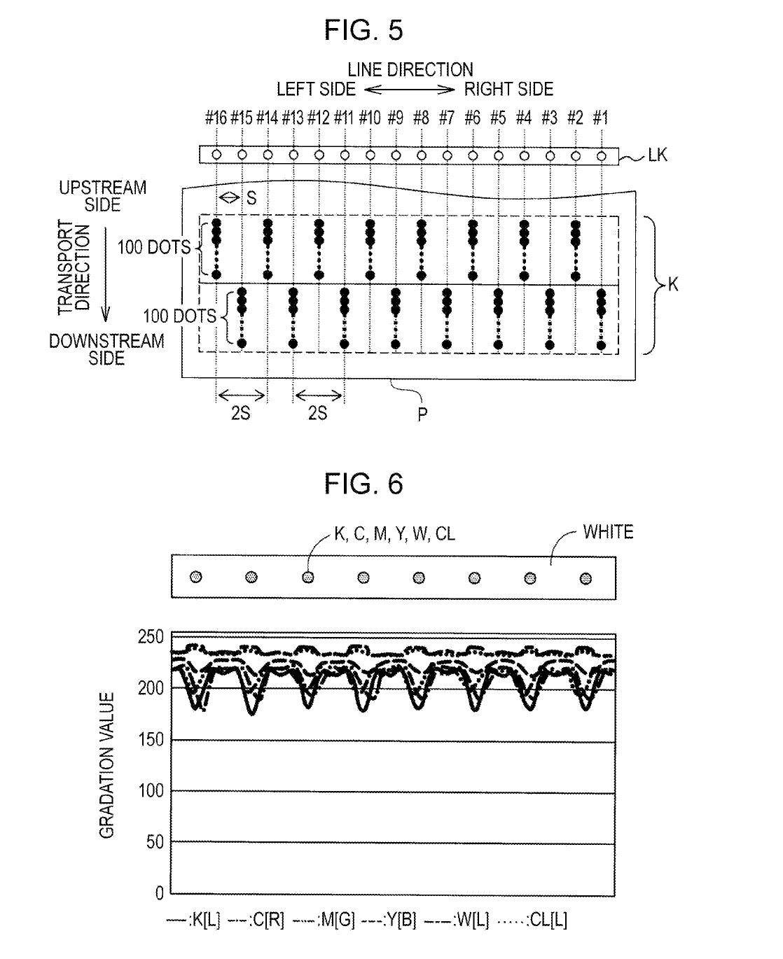

FIG. 5 is an explanatory diagram that shows an inspection pattern. FIG. 5 shows the inspection pattern formed by black nozzle rows LK. In the printer head 50 of the present embodiment, as shown in FIGS. 2A and 2B, the head 58 is placed in a zigzag shape, however, in order to facilitate the description hereinafter, as shown in FIG. 5, the nozzles are shown so as to be arranged in a row in the line direction. Furthermore, the number of the nozzles is reduced to 16, and the numbers of #1 to #16 from the right nozzle of the line direction are sequentially denoted.

By discharging ink from the nozzle row of the odd number and, then discharging ink from the nozzle of the even number, with respect to the print medium P transported under the printer head 50, the inspection pattern corresponding to one nozzle row is formed. The inspection pattern is constituted by the dot rows along the transport direction. In the present example, one dot row is constituted by 100 dots. Furthermore, in order to form the dot row by every other nozzle arranged in the line direction, two dot row groups (regions surrounded by dashed lines) arranged at an interval (in the present example, 360 dpi) twice the nozzle interval S in the line direction are formed in a row in the transport direction. One dot row group is called an “inspection pattern”. Furthermore, in the present example, the inspection pattern is pattern by every other nozzle arranged in the line direction, and two inspection patterns are formed in one nozzle row. When the two inspection patterns are particularly distinguished, for example, the patterns are referred to as an “even nozzle inspection pattern” and an “odd nozzle inspection pattern”. In addition, the inspection patterns of other inks are also identical to the inspection pattern of black shown in FIG. 5.

Moreover, in step S20 of FIG. 4, the image sensor 72 reads the inspection pattern printed on the print medium P in the order of being transported up to the reading position. However, the background color when reading the inspection pattern can be switched to the background color depending on the type of ink of the inspection pattern, by the background color switching mechanism 80. The background color is set as described below.

FIG. 6 is an explanatory diagram that shows a difference in reading results generated depending on the type of ink. FIG. 6 shows the result that the printing of the patterns of eight dots for each type of ink on the white print medium by the eight nozzles is read by the image sensor. In addition, in the case of each ink of black, white, and clear, an average value of gradation values detected by the portion detecting each color light of red (R), green (G), and blue (B) constituting the image sensor is used as a detected value. Furthermore, in the case of each ink of cyan, magenta, and yellow, the gradation value detected by the portion detecting the light colors of red, green and blue, which are complementary colors, is used as a detected value.

As is understood from FIG. 6, in the case of each color (normal ink) of back, cyan, magenta, and yellow, since light becoming the detection target is absorbed and the reflective light is reduced in the position of the dot pattern printed on the white print medium, respectively, the changed thereof can be detected. Meanwhile, in the case of the white ink, since the white ink is approximately the same as the background white, there is a tendency that the gradation value to be detected is slightly increased compared to the reflective light by the background white by the influence of an increase in reflective light to the interface of ink. However, as shown in FIG. 6, there is almost no difference, and it is difficult to discriminate presence or absence of the dot from the detection result. Similarly, even in the case of the clear ink, as shown in FIG. 6, there is almost no difference in gradation value detected by the presence or absence of the dot, and it is difficult to discriminate presence or absence of the dot from the detection result.

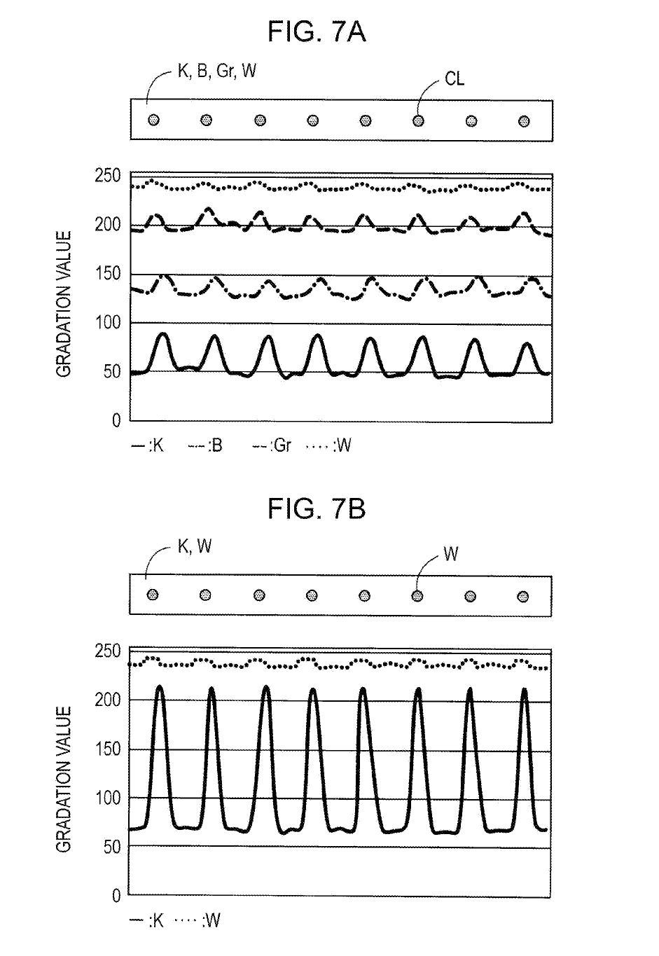

FIGS. 7A and 7B are explanatory diagrams that show a difference in reading results of the dot patterns between the clear ink and the white ink generated by the background color. FIG. 7A shows a result in which the printed result of the patterns of eight dots on the color print medium of four kinds of black (K), blue (B), gray (Gr), and white (W) by clear (CL) ink using eight nozzles shown in the upper end thereof is read by the image sensor. Furthermore, similarly, FIG. 7B shows a result in which the printed result of the patterns of eight dots on the color print medium of two kinds of black (K) and white (W) by white (W) ink using eight nozzles shown in the upper end thereof is read by the image sensor.

In the case of the clear ink, as is understood from FIG. 7A, in regard to the reflective light in the position of the dot of the clear ink, when reducing the reflective light in a position with no dot, that is, in the background color, and increasing a difference in intensity of reflective light detected by presence or absence of the dot, it is possible to increase a difference in gradation value detected in the position with the dot and the position with no dot of the clear ink, whereby it is easy to detect presence or absence of the dot of the clear ink. In addition, as is understood from FIG. 7A, black (K) has the greatest effect of reducing the reflective light. The reason is why black absorbs all the lights of red (R), green (G), and blue (B).

Even in the case of the white ink, like the case of the clear ink, as shown in FIG. 7B, in regard to the reflective light in the position of the dot of the white ink, when reducing the reflective light in a position with no dot, that is, in the background color, and increasing a difference in intensity of reflective light detected by presence or absence of the dot, it is possible to increase a difference in gradation value detected in the position with the dot and the position with no dot of the white ink, whereby it is easy to detect presence or absence of the dot of the white ink. In addition, similarly, black (K) has the greatest effect of reducing the reflective light.

Considering the points mentioned above, it is understood that the background color when reading the inspection pattern may be set as below.

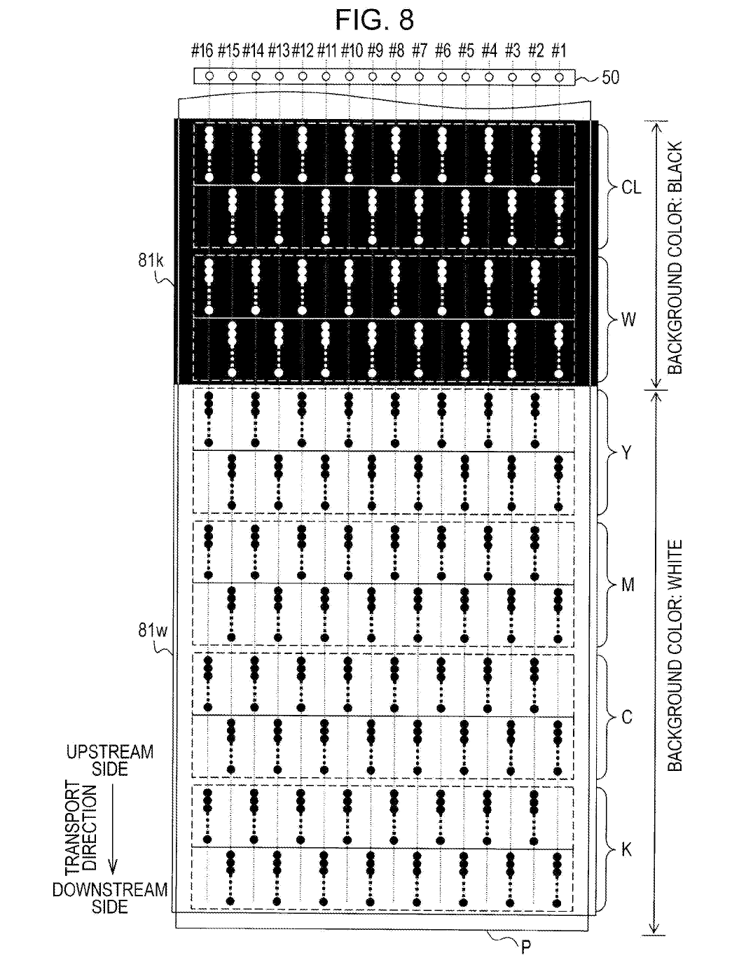

FIG. 8 is an explanatory diagram that shows a relationship between a type of ink and the background color. As shown in FIG. 8, in the case of each color of black (K), cyan (C), magenta (M), and yellow (Y), the background color is set to white (W). Moreover, in the case of clear (CL) and white (W), the background color is set to black (K).

In addition, the inspection pattern is preset and the position of the printing is also known, if the background color is switched depending on the position of the print medium P transported to the reading position based on information, it is possible to switch the background color depending on the type of ink of the inspection pattern.

Moreover, in step S30 of FIG. 4, it is determined whether or not the nozzle defect is generated based on the reading result of the inspection pattern, and the defective nozzle generated is specified.

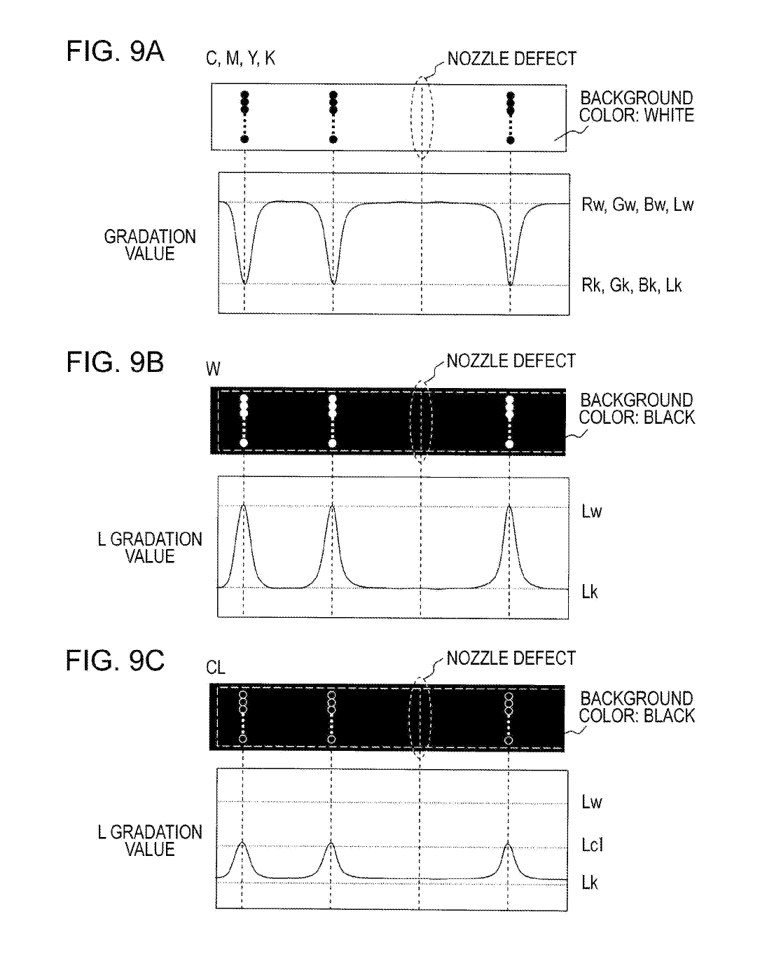

FIGS. 9A to 9C are explanatory diagrams that show the defect determination by the reading result of the inspection pattern. FIG. 9A shows the normal ink, FIG. 9B shows the white (W) ink, and FIG. 9C shows the clear (CL) ink.

In the case of the cyan (C) ink, light to be detected in the sensor section of red (R) of the image sensor 72 which is a complementary color is greatly changed between the section with the printed dot row and the section with no the printed dot row. Specifically, as shown in FIG. 9A, in the section with no the dot row, in the section of the background color white, most of R light is reflected and a gradation value Rw is detected. Meanwhile, in the section with the dot row, most of R light is absorbed, and a gradation value Rk (<Rw) is detected. Thus, in the position corresponding to the nozzle where the nozzle defect is not generated, the gradation value Rk is detected, and in the position corresponding to the nozzle where the nozzle defect is generated, a gradation value greater than the gradation value Rk is detected depending on the degree of defect. The example of FIG. 9A shows the case where the nozzles are clogged and the dot row is not printed at all, and in this case, the same gradation value Rw as that of the background color is detected. Thus, by presetting a threshold value of the defect determination and checking whether or not the gradation value smaller than the threshold value is detected in the position corresponding to the nozzle, it is possible to determine whether or not the nozzle defect is generated in the nozzle of cyan (C) and the defective nozzle can be specified. Specifically, if the gradation value smaller than the threshold value is detected, the nozzle defect is not generated, and the gradation value equal to or greater than the threshold value is detected, it is possible to determine that the nozzle defect is generated.

In addition, the same is also true for other normal inks, and each ink of magenta (M), yellow (Y), and black (K). However, the nozzle defect is determined by light detected in the sensor section of G light in the case of magenta (M), and the nozzle defect is determined by light detected in the sensor section of B light in the case of yellow (Y). In the case of black (K), the nozzle defect is determined by an average value of light detected in the sensor section of R light, G light and B (light). Furthermore, a value may be used in which the gradation values of each R, G, and B are added by a predetermined weighing but not the average value.

In the case of white (W) ink, light detected in each sensor section of R light, G light and B light of the image sensor 72 is greatly changed in the section with the printed dot row and the section with no the printed dot row. Specifically, as shown in FIG. 9B, in the section with no the dot row, that is, in the section of the black background color, most of R light, G light, and B light are absorbed and a gradation value Lk is detected as an average value of each color light. Meanwhile, in the section with the dot row, most of R light, G light, and B light are reflected, and a gradation value Lw (>Lk) is detected. Thus, in the position corresponding to the nozzle where the nozzle defect is not generated, the gradation value Lw is detected, and in the position corresponding to the nozzle where the nozzle defect is generated, a gradation value smaller than the gradation value Lw is detected depending on the degree of defect. The example of FIG. 9B shows the case where the nozzles are clogged and the dot row is not printed at all, and in this case, the same gradation value Lk as that of the background color is detected. Thus, by presetting a threshold value of the defect determination and checking whether or not the gradation value greater than the threshold value is detected in the position corresponding to the nozzle, it is possible to determine whether or not the nozzle defect is generated in the nozzle of white (W) and the defective nozzle can be specified. Specifically, if the gradation value greater than the threshold value is detected, the nozzle defect is not generated, and if the gradation value equal to or less than the threshold value is detected, it is possible to determine that the nozzle defect is generated.

In the case of the clear (CL) ink, like the case of the white ink, light detected in each sensor section of R light, G light, and B light of the image sensor 72 is also greatly changed in the section with the printed dot row and the section with no the printed dot row. Specifically, as shown in FIG. 9C, in the section with no the dot row, that is, in the section of the black background color, most of R light, G light, and B light are absorbed and the gradation value Lk is detected as an average value of each color light. Meanwhile, in the section with the dot row, R light, G light, and B light are partially reflected by the ink interface surface, and a gradation value Lcl (>Lk) is detected. Thus, in the position corresponding to the nozzle where the nozzle defect is not generated, the gradation value Lcl is detected, and in the position corresponding to the nozzle where the nozzle defect is generated, a gradation value smaller than the gradation value Lcl is detected depending on the degree of defect. The example of FIG. 9C shows the case where the nozzles are clogged and the dot row is not printed at all, and in this case, the same gradation value Lk as that of the background color is detected. Thus, by presetting a threshold value of the defect determination and checking whether or not the gradation value greater than the threshold value is detected in the position corresponding to the nozzle, it is possible to determine whether or not the nozzle defect is generated in the nozzle of clear (CL) and the defective nozzle can be specified. Specifically, if the gradation value greater than the threshold value is detected, the nozzle defect is not generated, and if the gradation value equal to or less than the threshold value is detected, it is possible to determine that the nozzle defect is generated.

### A3. Effect

In the present example, when inspecting the defective nozzle, the colorless transparent film is used as the print medium and the inspection pattern is printed thereon. When reading the printed inspection pattern by the image sensor, in a case where the type of ink of read inspection pattern is the normal ink of black (K), cyan (C), magenta (M), and yellow (Y), the background color is set to white, and in the case of a special ink of white (W) and clear (CL), the background color is set to black, whereby the reading of the inspection pattern is executed. As a result, it is possible to solve the problem in that it is difficult to perform the detection of the defective nozzle of white (W) or clear (CL) ink, as described in the example of the related art, and to improve a time required for the detection of the defective nozzle.

### A4. Modified Example of Background Color Switching Mechanism

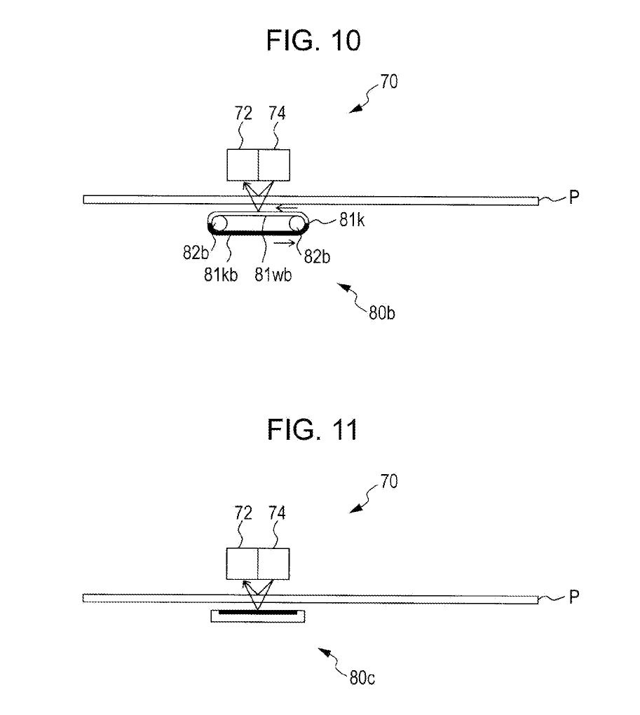

FIG. 10 is an explanatory diagram that shows a modified example of the background color switching mechanism. A background color switching mechanism 80b drives a belt-like film 81b provided around two rotation rollers 82b by a driving motor (not shown) in an arrow direction, and has a structure which switches the background color of the reading position of the image sensor 72 to white by a white region 81wb or black by a black region 81k.

FIG. 11 is an explanatory diagram that shows another modified example of the background color switching mechanism. A background color switching mechanism 80c is constituted by a liquid crystal panel. A structure thereof is such that the background color is switched to white or black by setting color of the screen of the liquid crystal panel to white or black.

As mentioned above, the background color switching mechanism is not limited to the background color switching mechanism 80 of the embodiment mentioned above, but, like the modified examples shown in FIGS. 10 and 11, the same may be realized by various structures. That is, the background color switching mechanism may have a structure that is able to switch the background color of the reading position to white or black, depending on the type of ink of the inspection pattern that is read in the reading position.

### B. MODIFIED EXAMPLE

In addition, the invention is not limited to the embodiments mentioned above, but can be carried out in various forms in the scope not departing from the gist thereof, and, for example, the modifications as below are also possible.

### B1. Modified Example 1

In the embodiments mentioned above, cyan (C), magenta (M), yellow (Y), and black (K) are used as the normal ink, however, if any ink absorbs light of wavelength components of a visible light region, without being limited thereto, the ink can be used as the normal ink. As the normal ink, for example, it is possible to use a special color ink such as red (R), green (G), blue (B), and orange (Or) to be used for widening a color reproduction region, a light shade ink such as light cyan (LC), light magenta (LM), gray (LK), and light gray (LLK), or the like.

### B2. Modified Example 2

In the embodiment mentioned above, a case was described as an example where the background color of the normal ink is switched to white, and the background colors of white (W) and clear (CL) as the special ink are switched to black. However, there is no need to limit the background color of the normal ink to white, the background color may be switched depending on the type of ink. For example, cyan (C) may switch the complementary color of red (R) as the background color, magenta (M) may switch the complementary color of green (G) as the background color, and yellow (Y) may switch the complementary color of blue (B) as the background color, respectively. In this case, the same effect can also be obtained. Furthermore, the complementary color is not necessarily required, in the color circle, at least, color (color including at least the complementary color), which is situated at a complementary color side to color of ink becoming the target and reflects the color light of the complementary color, may be switched as the background color. However, it is preferable to use color of the range equal to or less than ±60°, more preferably, ±30°, on the basis of the complementary color of the color of ink becoming the target. Furthermore, the complementary color of the color of ink becoming the target is most preferable. The reason is because it is possible to increase a difference in intensity of light of the reflective light in the dot and the reflective light in the background color.

That is, the invention may switch the background color of the reading position depending on the type of ink of the inspection pattern and perform the reading of the inspection pattern in the reading position.

### B3. Modified Example 3

In the embodiment mentioned above, the colorless inspection film was described as an example, but if a difference in intensity of the reflective light between the background color and the dot can be detected, colorlessness may not be used.

### B4. Modified Example 4

In the embodiment mentioned above, the line head was described as an example, but, the invention is not necessarily limited thereto, and if a print head having a plurality of nozzles each discharging multiple types of ink is used, the invention can be applied to a printer (a printing apparatus) having any print head.

### B5. Modified Example 5

In the embodiment mentioned above, a part of the configuration realized by hardware may be switched to software, and on the contrary, a part of the configuration of software may be switched to hardware.

The entire disclosure of Japanese Patent Application No. 2011-016160, filed Jan. 28, 2011 is expressly incorporated by reference herein.

What is claimed is:

1. A printing apparatus comprising:
a print head having a plurality of nozzle groups which discharges multiple types of ink, respectively;
a print control section which controls the operation of the print head, and prints inspection patterns of each ink on a transparent medium;
a sensor which reads the inspection patterns printed on the transparent medium;
a background color switching section which faces the sensor with the inspection patterns interposed therebetween and in which a background color is switched; and
a defect determination section which determines an occurrence of a defective nozzle based on a reading result in which the background color and the inspection pattern are read by the sensor.

2. The printing apparatus according to claim 1,
wherein the background color switching section switches the background color depending on the type of ink of the read inspection pattern.

3. The printing apparatus according to claim 1,
wherein the background color switching section has a background plate.

4. The printing apparatus according to claim 1,
wherein the background color switching section has a film.

5. The printing apparatus according to claim 1,
wherein the background color switching section has a liquid crystal panel.

6. The printing apparatus according to claim 1,
wherein the multiple types of ink include at least one of white ink and transparent ink, and
when the type of ink of the inspection pattern to be read is the white ink or the transparent ink, the background color is black.

7. The printing apparatus according to claim 1,
wherein the multiple types of ink include a plurality of color inks,
when the type of ink of the inspection pattern to be read is one color ink among the plurality of color inks, the background color includes at least a component of a complementary color in a color circle of the one color.

8. The printing apparatus according to claim 7,
wherein, when the type of ink of the inspection pattern to be read is one color ink among the plurality of color inks, the background color is the complementary color in the color circle of the one color.

9. A printing method comprising:
printing an inspection pattern of each ink on a transparent medium by the use of a print head having a plurality of nozzle groups which discharges multiple types of ink, respectively;
reading the inspection pattern printed on the transparent medium by the use of a sensor;
switching a background color by the use of a background color switching section which faces the sensor with the inspection pattern interposed therebetween and in which a background color is switched, when reading the inspection pattern; and
determining an occurrence of a defective nozzle based on a reading result in which the background color and the inspection pattern are read by the sensor.
